(19) United States
(12) Patent Application Publication
(10) Pub. No.: US 2026/0236548 A1
(43) Pub. Date: Aug. 13, 2026

(54) GENERATING AND UTILIZING COMPRESSED GROUNDING DATA FOR SEARCH ENGINES THAT UTILIZE GENERATIVE ARTIFICIAL INTELLIGENCE MODELS

(71) Applicant: Microsoft Technology Licensing, LLC, Redmond, WA (US)

(72) Inventors: Anant KHANDELWAL, Karnataka (IN); Puneet AGRAWAL, Jaipur (IN); Tushar SINGHAL, Begaluru (IN); Manish GUPTA, Hyderabad (IN)

(21) Appl. No.: 19/096,259

(22) Filed: Mar. 31, 2025

(30) Foreign Application Priority Data
Feb. 13, 2025 (IN) 202511012227

(51) Int. Cl. G06F 16/9538

(52) U.S. Cl. CPC G06F 16/9538

(57) ABSTRACT

This disclosure describes utilizing a grounding compression system within a search results system to create compressed grounding data to enhance and improve generative search engines (GSEs). For example, the grounding compression system (e.g., a grounding data compression system) dynamically and intelligently reduces large amounts of grounding information into amounts compatible with generative AI models used to answer or provide responses to search queries. Indeed, rather than merely reducing the size of grounding information obtained from a search query, the grounding compression system intelligently distills, condenses, and prunes the grounding data into a compressed block that focuses on the search query, enabling the generative AI model to more efficiently and accurate create a generative response to the search query.

### CROSS-REFERENCE TO RELATED APPLICATIONS

This application claims benefit and priority to Indian Provisional Application No. 202511012227, filed on February 13, 2025, which is hereby incorporated by reference in its entirety.

### BACKGROUND

In recent years, there have been significant advancements in both hardware and software domains, specifically in the field of internet search. For example, generative search engines (GSEs) leverage large-scale language models (LLMs) and other generative artificial intelligence (AI) models to interpret user queries, retrieve relevant content, and generate contextually meaningful responses. However, as the number of accessible resources continues to grow, existing systems have limitations in their ability to efficiently and effectively utilize generative AI models. To elaborate, key technological challenges such as information overload and latency result in inaccurate or low-quality responses. Indeed, these and other issues are present in current search result systems.

### BRIEF DESCRIPTION OF THE DRAWINGS

The following detailed description provides specific implementations accompanied by drawings. Additionally, each of the figures listed below corresponds to one or more implementations discussed in this disclosure.

FIG. 1 illustrates an overview of an example grounding compression system within a search results system generating compressed grounding data for a generative artificial intelligence (AI) model of a generative search engine to facilitate more accurate and efficient responses to a search query.

FIG. 2 illustrates an example computing environment where the grounding compression system is implemented.

FIG. 3 illustrates an example overview diagram of the grounding compression system creating, in response to a search query, compressed grounding data to provide a generative AI model for accurately and efficiently responding to the search query.

FIG. 4 illustrates a high-level flow diagram for generating compressed grounding data for a search query.

FIG. 5 illustrates a flow diagram for performing a freshness evaluation as part of generating compressed grounding data for a search query.

FIG. 6 illustrates a flow diagram for performing a credibility evaluation as part of generating compressed grounding data for a search query.

FIG. 7 illustrates a flow diagram for performing grounding data summarization as part of generating compressed grounding data for a search query.

FIG. 8 illustrates a flow diagram for creating dense vector embeddings as part of generating compressed grounding data for a search query.

FIG. 9 illustrates a flow diagram for performing data handling with grounding data for a search query.

FIG. 10 illustrates an example series of acts of a computer-implemented method for providing one or more query responses using one or more artificial intelligence models.

FIG. 11 illustrates example components included within a computer system used to implement the grounding compression system and/or search results system.

### DETAILED DESCRIPTION

This disclosure describes utilizing a grounding compression system within a search results system to create compressed grounding data to enhance and improve generative search engines (GSEs). For example, the grounding compression system (e.g., a grounding data compression system) dynamically and intelligently reduces large amounts of grounding information into sizes compatible with generative AI models used to answer or provide responses to search queries. Indeed, rather than merely reducing the size of grounding information obtained from a search query, the grounding compression system intelligently distills, condenses, and prunes the grounding data into a compressed block that focuses on the search query, enabling the generative AI model to more efficiently and accurately create a generative response to the search query.

Implementations of the present disclosure provide benefits and solve problems in the art with systems, computer-readable media, and computer-implemented methods that utilize the grounding compression system to efficiently compress grounding data presented to a generative AI model. This enables the generative AI model to create generative responses to search queries in less time and without compromising the quality and accuracy of the generated responses. The grounding compression system provides an innovative system architecture designed to optimize data processing in generative AI models through advanced compression techniques. In particular, the grounding compression system achieves reduced data volume in grounding information, prioritizes information relevant to search queries, and facilitates efficient integration with generative AI models.

To better understand the technical benefits of the grounding compression system, consider some existing search result systems. Existing systems have a standard architecture that creates large amounts of overhead for generative AI models to process. Indeed, the input data provided to the generative AI model is extensive and lengthy. This creates several technical problems. For example, when the amount of input data (e.g., grounding data) is extensive and exceeds the token limit of the generative AI model, multiple calls to the generative AI model must be made to provide the grounding data. Each call requires significant processing by the generative AI model. Alternatively, if few calls are made, the generative AI model may not be able to consider all the information, leading to incomplete or less accurate responses.

As another example, when there is extensive grounding data, generative responses are often inaccurate as they suffer from being generalized and random. This often creates frustration for users, who then submit additional queries to seek answers to the original search query. Along these lines, long input prompts with extensive grounding data can cause the generative AI model to experience lost-in-the-middle errors, which lead to confusion and incoherence in processing the search query. Furthermore, long prompts can also cause recency bias, leading to inaccurate responses. Indeed, high-quality generative responses require efficient synthesis of relevant data. Overloading the generative AI model with excessive or irrelevant information can result in verbose, incoherent, or inaccurate responses, diminishing the utility of the search engine response.

In another example, extensive grounding data causes longer latency periods. For instance, the process of retrieving, processing, and synthesizing data into a generative response is often time-intensive, particularly as data volumes grow. By providing increasing amounts of grounding data, the overall process lengthens in time and also requires additional bandwidth to send and receive data. This latency can significantly hinder the process when trying to achieve real-time or near-instantaneous responses. Furthermore, these prolonged latency periods can significantly degrade the user experience.

As mentioned, in many instances, the grounding compression system (e.g., a grounding data compression system within a search results system) addresses and resolves the above problems. In particular, the grounding compression system delivers several significant technical benefits in terms of improved accuracy, efficiency, and flexibility compared to existing search results systems. Moreover, the grounding compression system provides several practical applications that address issues related to delivering search results in response to search queries.

To elaborate, the grounding compression system improves computational efficiency by reducing the volume of data provided to a generative AI model (e.g., reducing bandwidth), creating fewer calls to the generative AI model since grounding data can be provided in a single call, and simplifying the processing required by the generative AI model (e.g., fewer computing resources are needed to generate responses). Indeed, in various implementations, the grounding compression system provides compressed grounding data to the generative AI model that removes redundancies and irrelevant information, thereby minimizing the computational load and enabling faster and more efficient processing.

Furthermore, the grounding compression system provides a framework for a streamlined retrieval-augmented generation (RAG) pipeline that integrates the compressed grounding data into a generative response pipeline to optimize query processing. Indeed, this pipeline enables efficient interaction with the generative AI model for generating responses by minimizing computational overhead while ensuring that responses remain coherent and accurate.

In many implementations, the grounding compression system efficiently narrows down the scope of data retrieval (e.g., grounding data) by processing it in a compact format (e.g., compressed grounding data) and generating responses based on high-quality data, all while maintaining a high level of relevance to the search query. For example, by generating compressed grounding data, the grounding compression system enables a generative AI model to handle large volumes of data with minimal computational overhead.

In various implementations, the grounding compression system achieves compressed grounding data by using data volume reduction (e.g., distilled summarization), embedding generation, or both. For instance, grounding data summarization provides concise summaries of input text while retaining its essential meaning and context. Embedding generation creates dense vector embeddings that capture the meaning and context of grounding data content in a numerical format, enabling the generative AI model to perform efficient computations, retrievals, clustering, and other streamlined functions. Indeed, by generating dense vector embeddings, the grounding compression system ensures that the compressed grounding data is both computationally efficient and semantically rich.

Furthermore, as stated above, by generating compressed grounding data, the grounding compression system operates with lower computational overhead, as less data is passed through each processing stage. This directly translates into computational cost savings in terms of both hardware and energy consumption. By reducing the amount of data that needs to be processed, the search results system can handle more queries simultaneously without a proportional increase in computational resources. This is particularly important in large-scale environments with numerous search queries or in environments where resources are limited.

Moreover, reduced resource consumption also contributes to improved system reliability. By avoiding overburdening the infrastructure, the search results system remains more stable, responsive, and less prone to crashes or slowdowns. This efficiency allows for better scalability (e.g., flexibility), enabling the system to handle a higher volume of requests without requiring significant infrastructure upgrades.

As mentioned above, the grounding compression system improves accuracy. In various implementations, the compressed grounding data emphasizes relevance, freshness, and credibility. For instance, the grounding compression system removes duplicative and stale grounding data, which often confuses or degrades generative responses.

As another benefit, the grounding compression system reduces latency. To elaborate, the grounding compression system leverages compression techniques that minimize the amount of data that needs to be processed by the generative AI model. By compressing grounding data, such as retrieved documents or snippets, the grounding compression system effectively condenses large and complex datasets into smaller, more manageable formats. This results in faster processing times, as the generative AI model has to handle fewer tokens or data points, which directly translates into quicker response times. Reduced latency is especially crucial in real-time applications, where users expect immediate or near-instantaneous responses. Whether in chatbots, search engines, or any other real-time application, the ability to provide fast, accurate responses enhances the user experience.

The grounding compression system can also improve computational flexibility. For example, the grounding compression system utilizes grounding data summarization and embedding generation to ensure versatility and robustness in handling diverse data types and scenarios. In various implementations, the grounding compression system ensures that all forms of input are processed effectively, maintaining both accuracy and efficiency throughout the entire query processing cycle.

Regarding computational flexibility, the grounding compression system also improves scalability. To elaborate, as data volumes continue to grow and user demands increase, the grounding compression system is designed to scale seamlessly without compromising performance. By generating compressed grounding data and optimizing data processing, the grounding compression system can handle vast amounts of data while still maintaining fast response times and low resource consumption. Whether handling thousands of user queries in real time or processing large datasets for analytical tasks, the system can expand to meet increasing demands. Indeed, the modular architecture of the grounding compression system allows it to adapt to varying load conditions, scaling up or down as necessary without requiring major changes to the underlying infrastructure. This adaptability ensures that the grounding compression system and the search results system remain effective, regardless of the size of the data or the number of simultaneous users.

As illustrated in the preceding discussion, this disclosure uses a variety of terms to describe the features and advantages of one or more described implementations. For instance, this disclosure describes the grounding compression system within the context of a cloud computing system.

As an example, a “generative artificial intelligence (AI) model” is an artificial intelligence system that utilizes deep learning and a large number of parameters (e.g., in the billions or trillions), which are trained and/or fine-tuned on one or more extensive datasets to produce coherent, contextually relevant, and fluently topic-specific outputs (e.g., text and/or images). In many instances, a generative model refers to an advanced computational system that uses natural language processing, machine learning, and/or image processing to generate coherent and contextually relevant human-like responses.

Generative AI models (both large and small) have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats, ranging from comprehensive generative summaries and generative visual digests of several types to direct answer generative documents.

Moreover, generative AI models are primarily based on transformer architectures for understanding, generating, and manipulating human language. Generative AI models can also utilize other types of architectures, such as recurrent neural networks (RNNs), long short-term memory (LSTM) models, convolutional neural networks (CNNs), and other architectures. Examples of generative AI models include generative pre-trained transformer (GPT) models like GPT-3.5, GPT-4, and GPT-4o; bidirectional encoder representations from transformers (BERT) models; text-to-text transfer transformer models like T5; conditional transformer language (CTRL) models; and Turing-NLG. Other types of generative AI models include sequence-to-sequence models (Seq2Seq), vanilla RNNs, and LSTM networks. In some instances, a generative AI model includes a large generative AI model (LGM), a small generative AI model (SGM), a large language model (LLM), a small language model (SLM), and a small action model (SAM), which serve as text-based versions of generative AI models that receive text prompts and/or generate text outputs. In various implementations, a generative AI model is a multimodal generative model that receives multiple input formats (e.g., text, images, video, and data structures) and/or generates multiple output formats.

As an example, the terms “prompt,” “model prompt,” and “generative AI model prompt” refer to a request made to a generative AI model to create a generative AI model output based on plain language guidance. In some instances, the grounding compression system provides additional information along with a prompt. A prompt can include important contextual information and/or general framing information to ensure that the generative AI model understands the correct context, syntax, and grounding information of the data it is processing. Prompts can include user prompts, which are based on user input or a search query, and system prompts, which can include search contexts, parameters, safeguards, and policies. Examples of prompts are provided below.

As an example, the term “search results” refers to website links (e.g., hyperlinks), search query answers, and their corresponding resources (e.g., grounding data or grounding information). Search results are obtained in response to a search query (e.g., a user-requested search query). Often, a search results system identifies and returns search results from search indexes, using neural networks or generative AI models to identify relevant search results.

As another example, the terms “grounding data” and “grounding information” refer to verifiable data obtained from search results, which are provided to a generative AI model to assist in processing a prompt. Grounding data can include search result links, metadata, media, summaries, and various data formats. For instance, grounding data might consist of URLs to relevant web pages, information about the data such as publication date and author, images, videos, audio clips, brief overviews of longer articles, and structured data like tables or charts. Indeed, grounding data is used to ensure that a generative AI model produces responses that are factually accurate, contextually relevant, and applicable to real-world scenarios.

The terms “compressed grounding data,” “compressed grounding information,” and “compressed data” refer to grounding data that has been reduced in size while enhancing its enhanced substance and content. For example, compressed grounding data includes data that is minimized to fit within a token limit of a generative AI model. Compressing grounding data can involve generating concise summaries of input text while retaining its essential meaning and context, selecting key sentences or phrases directly from the source text to construct a summary, identifying influential sentences based on their interconnectivity, prioritizing sentences appearing in key positions, and/or structuring the data into manageable components. Compressed grounding data may be generated by distilling and summarizing key concepts central to the search query, and generating embeddings to further represent grounding data in numerical form (e.g., generating compact and machine-readable representations of the semantic content).

As an example, the term “generative search results document” (“generative document,” for short) refers to a search-based document that includes curated narrative text responses corresponding to a search query and its corresponding set of search link results. Generative search results documents can be created in various forms to best suit responses to the search query.

As another example, the terms “related answers” or “answer card” refer to an element that provides direct answers to a search query or sub-queries derived from the search query. Related answers may be included as grounding data and can provide quick, accurate responses to questions without requiring further search or interaction by a user. Related answers can include text, images, audio, video, and/or animations to convey a prompt answer. In addition, related answers may include various versions that include different granularities of information and/or have different layout dimensions (e.g., available dimensions). Furthermore, related answers include metadata and/or other grounding information to allow a generative AI model to understand the context associated with the related answer (e.g., answer card).

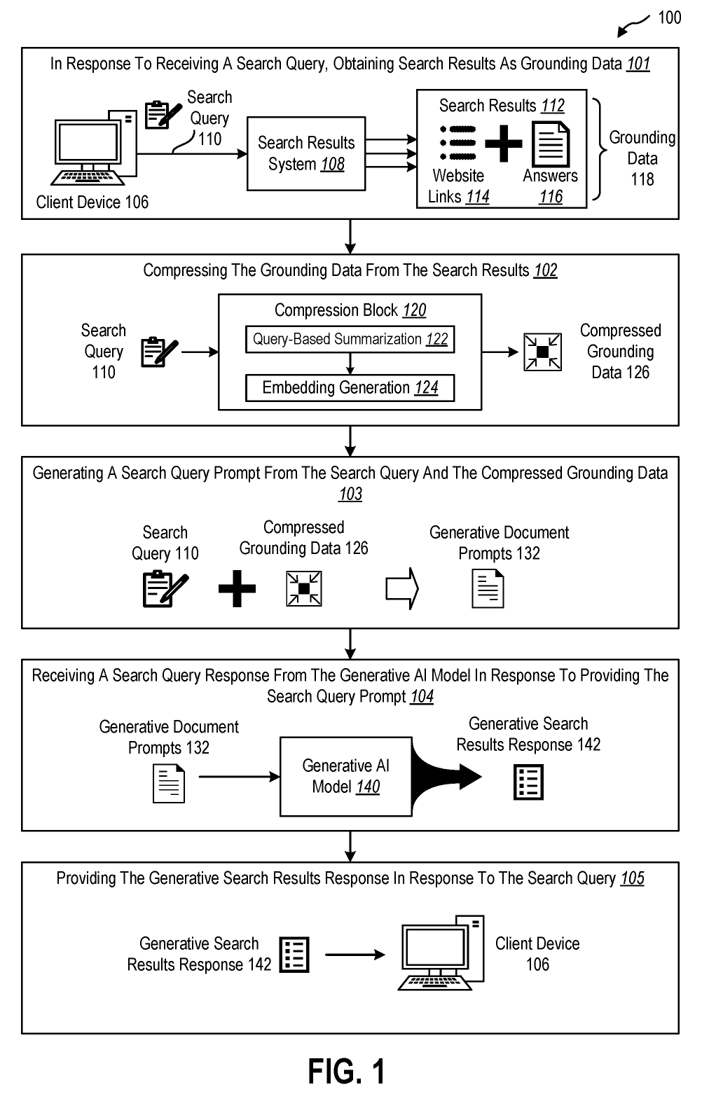

Implementation examples and details of the grounding compression system are discussed in connection with the accompanying figures, which are described next. For example, FIG. 1 illustrates an overview of a grounding compression system within a search results system generating compressed grounding data for a generative artificial intelligence (AI) model of a generative search engine to facilitate more accurate and efficient responses to a search query according to some implementations. While FIG. 1 provides a high-level overview of the invention, additional details are provided in subsequent figures.

FIG. 1 illustrates a series of acts 100 performed by or in connection with the grounding compression system. As shown, the series of acts 100 briefly illustrates an example of how the grounding compression system generates compressed grounding data for a search query to provide to a generative AI model, which uses the compressed grounding data to create an efficient and accurate generative response to the search query.

As shown, the series of acts 100 includes act 101 of receiving a search query and, in response, obtaining search results as grounding data. For example, a client device 106 provides a search query 110 to a search results system 108 that retrieves or otherwise obtains search results 112. As shown, the search results 112 can include website links 114, answers 116, and other forms of grounding data 118. Indeed, the grounding data 118 can include contextual information about the identified website links and/or related answers.

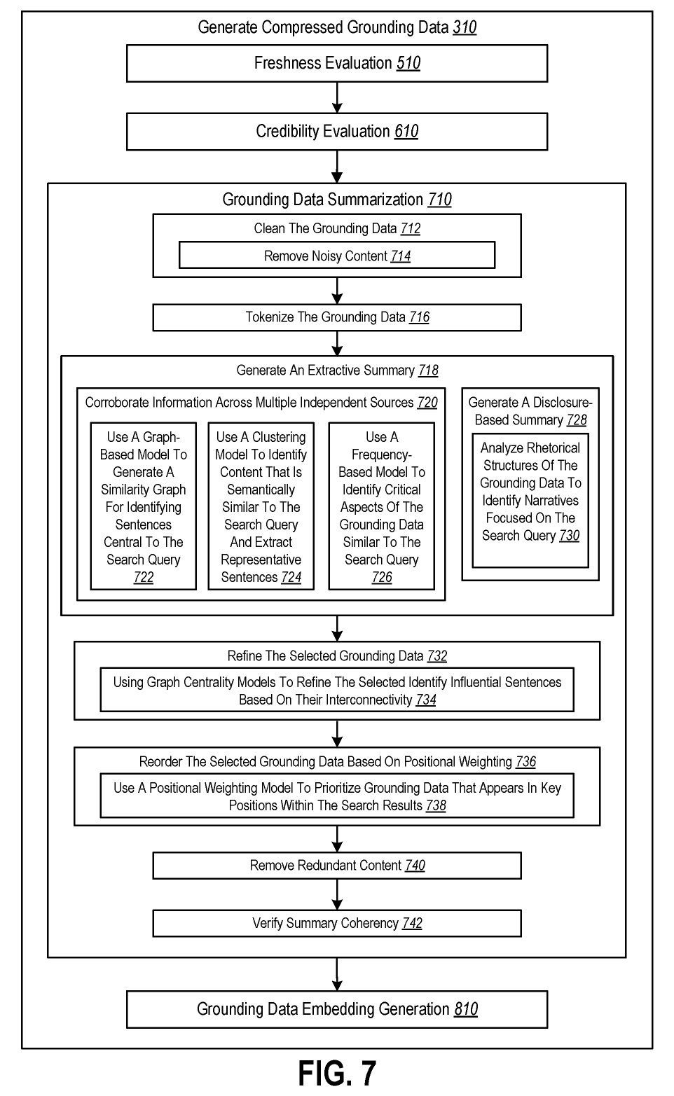

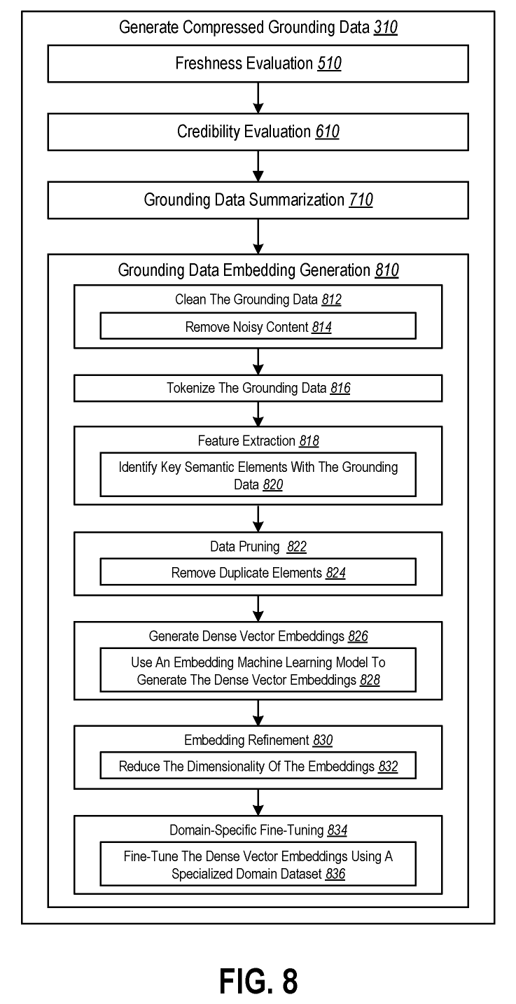

Act 102 includes compressing the grounding data from the search results. For example, the grounding compression system receives the search query 110 and the grounding data 118 from the search results system 108 (e.g., the grounding compression system may be part of the search results system). The grounding compression system may utilize a compression block 120, which includes various compression techniques, to generate compressed grounding data 126 that reduces the volume of grounding data while focusing and/or targeting the data on the search query 110. As shown, the compression block 120 includes query-based summarization 122 and embedding generation 124. Additional details regarding query-based summarization are provided in connection with FIG. 7, among other places. Additional details regarding embedding generation are provided in connection with FIG. 8, among other places.

Act 103 includes generating a search query prompt from the search query and the compressed grounding data. In various implementations, the grounding compression system generates generative document prompts 132 for the search query 110 to be answered based on the compressed grounding data 126. The grounding compression system can provide the generative document prompts 132 to a generative AI model 140.

Act 104 includes receiving a search query response from the generative AI model in response to providing the search query prompt. For example, the grounding compression system provides the generative document prompts 132 to the generative AI model 140 with instructions for the generative AI model 140 to process the search query 110 using the compressed grounding data 126. Because the grounding data is compact, the generative AI model 140 quickly, efficiently, and accurately generates a generative search results response 142 to the search query 110.

Act 105 includes providing the generative search results response in response to the search query. For instance, upon receiving the generative search results response 142, the grounding compression system may format the response and/or provide it to the client device 106 in response to the search query 110. Because the grounding compression system provided compressed grounding data 126 to the generative AI model 140, which was able to quickly generate the generative search results response 142, the process may occur in real time or near-real time.

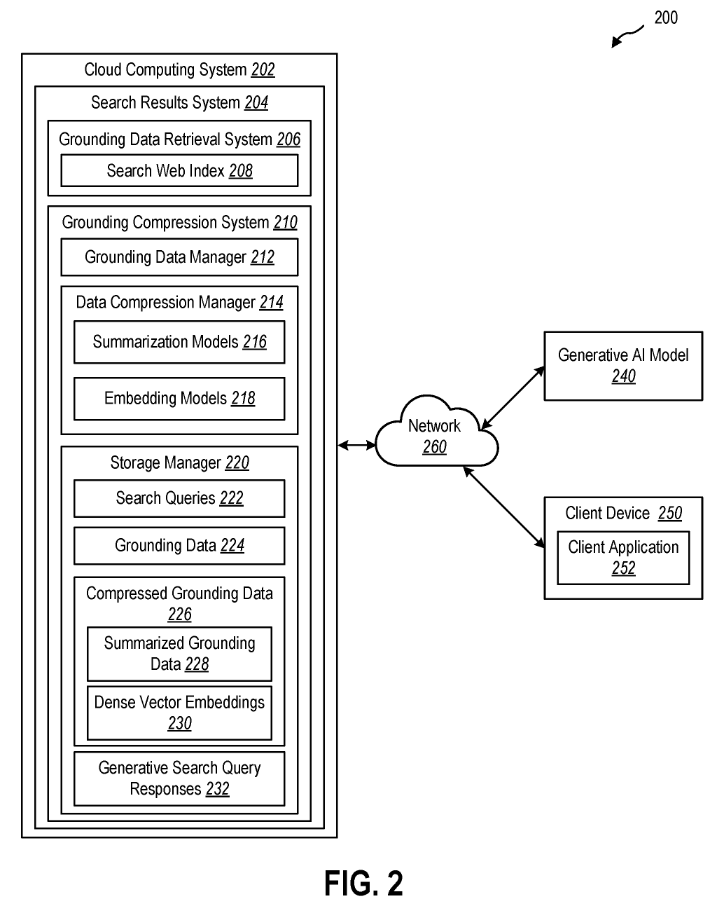

With a general overview in place, additional details are provided regarding the components, features, and elements of the grounding compression system. To illustrate, FIG. 2 shows an example computing environment where the grounding compression system is implemented according to some implementations. In particular, FIG. 2 illustrates an example of a computing environment 200 with various computing devices, including a cloud computing system 202 associated with a grounding compression system 210. While FIG. 2 shows example arrangements and configurations of the computing environment 200, the cloud computing system 202, the grounding compression system 210, and associated components, other arrangements and configurations are possible.

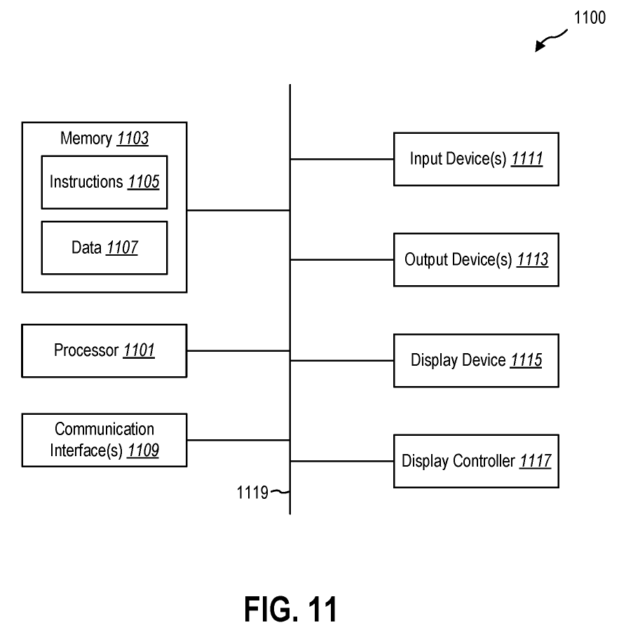

As shown, the computing environment 200 includes a cloud computing system 202 associated with the grounding compression system 210, a generative AI model 240, and a client device 250 with a client application 252, connected via a network 260. Many of these components may be implemented on one or more computing devices, such as one or more server devices, while some of these components may be implemented on personal devices. Further details regarding computing devices are provided below in connection with FIG. 11, along with additional details regarding networks, such as the network 260 shown.

Before describing the components of the cloud computing system 202, including the grounding compression system 210, other components of the computing environment 200 are discussed first to provide better context for the grounding compression system 210. As shown, the computing environment 200 includes the generative AI model 240, which corresponds to one or more generative models tuned to efficiently perform various operations. The generative AI model 240 can include small generative AI models (SGMs) and/or large generative models (LGMs). For instance, a small generative AI model is fine-tuned to perform particular tasks, while a large generative AI model performs a broader range of tasks. In some implementations, one of the small or large generative AI models is a text-based generative AI model or a large text-only generative model that inputs and outputs text data (e.g., no images or audio), which runs more efficiently and returns results more quickly than multimodal models. In some implementations, the generative AI model is a multimodal model that can process inputs and generate outputs of different data types.

As shown, the computing environment 200 includes the client device 250. In various implementations, the client device 250 is associated with a user (e.g., a user client device) who requests a search query. In various instances, the client device 250 includes a client application 252, such as a web browser, mobile application, or another form of computer application for accessing and/or interacting with the cloud computing system 202 and/or the grounding compression system 210. For example, the client device 250 interacts with generative content (e.g., text narrative responses and corresponding answer cards) within a formatted generative search results document via the client application 252.

Returning to the cloud computing system 202, as shown, the cloud computing system 202 includes a search results system 204 with a grounding data retrieval system 206 and the grounding compression system 210. In various implementations, the search results system 204 receives search queries from client devices and provides search results in response. For example, the client device 250 submits a search request, and the search results system 204 uses the grounding data retrieval system 206 to obtain grounding data for the search query using a search web index 208. The search results system 204 uses the grounding compression system 210 to create a generative search results response for the search query.

As shown, the grounding data retrieval system 206 includes a search web index 208. In various implementations, the search web index 208 returns a set of search link results (e.g., websites) and/or answers related to a search query. More generally, the grounding data retrieval system 206 obtains grounding data for a search query in response to a search request. In various implementations, the grounding data retrieval system 206 utilizes generative AI models to obtain grounding data.

Regarding the grounding compression system 210, as shown, the grounding compression system 210 includes various components and elements implemented in hardware and/or software. For example, the grounding compression system 210 includes a grounding data manager 212, a data compression manager 214 that has summarization models 216 and embedding models 218, and a storage manager 220. The storage manager 220 includes search queries 222, grounding data 224, compressed grounding data 226 having summarized grounding data 228 and dense vector embeddings 230, and generative search query responses 232.

As mentioned, the grounding compression system 210 includes the grounding data manager 212, which facilitates obtaining grounding data. For example, the data compression manager 214 communicates with the grounding data retrieval system 206 to get grounding data 224 for the search queries 222. Grounding data 224 can include web links, relevant or related answers, and other retrieved information associated with a search query.

The grounding compression system 210 includes the data compression manager 214, which builds compressed grounding data 226 of various types, including summarized grounding data 228 and dense vector embeddings 230. For example, the data compression manager 214 utilizes summarization models 216 to generate summarized grounding data 228 and embedding models 218 to produce or generate generative AI model 240, as further described below.

In addition, the data compression manager 214 can communicate with the generative AI model 240. For instance, the data compression manager 214 provides search query prompts to the generative AI model 240, which include search queries 222 and compressed grounding data 226, and the generative AI model 240 returns generative search query responses 232.

In some implementations, the generative search query responses 232 include generative documents, such as a generative search engine results page (SERP). In various implementations, the search results system 204 provides the generative search query responses 232 to the client device 250 in response to the search queries 222.

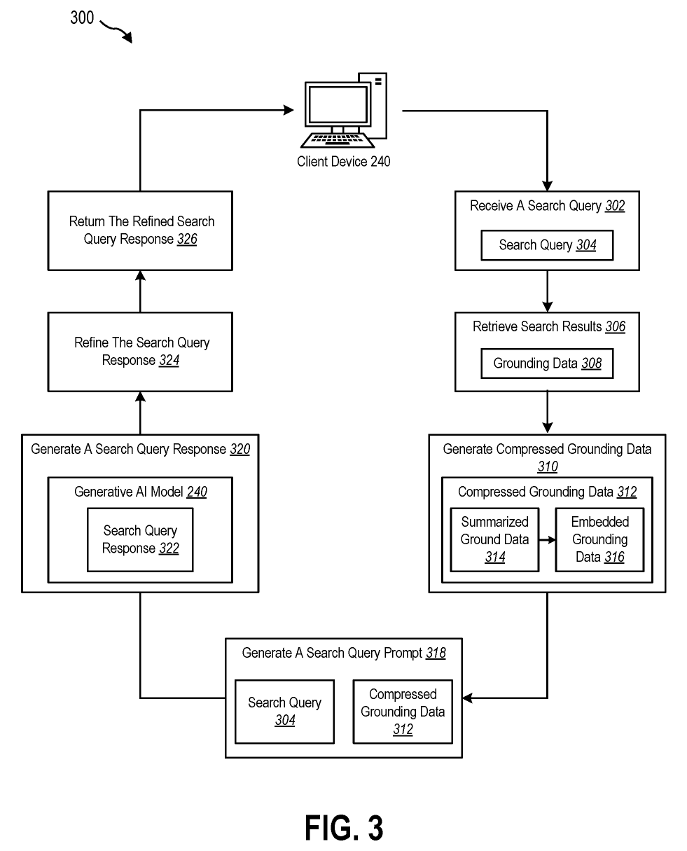

Turning to the next figure, FIG. 3 provides an overview of creating generative search result responses using compressed grounding data. In particular, FIG. 3 illustrates an example overview diagram of the grounding compression system creating, in response to a search query, compressed grounding data to provide a generative AI model for accurately and efficiently responding to the search query according to some implementations. As shown, FIG. 3 includes the client device 250 and a series of acts 300 performed by or in connection with the grounding compression system 210.

As mentioned above, the grounding compression system 210 generates shorter grounding data without the loss of useful information. Indeed, a central technical problem that the grounding compression system 210 solves is reducing the size of any grounding data within the token limits of a generative AI model while not losing any key pieces of information. As mentioned above and further described below, the grounding compression system 210 achieves high compression rates and high accuracy while creating reduced latency and lower capacity requirements for the generative AI model.

As shown, the series of acts 300 includes act 302 of receiving a search query. For example, the client device 250 provides a question to a generative chat service (e.g., the search results system) in the form of a search query 304. In various instances, receiving the search query 304 initiates the generative search query response framework or pipeline, triggering subsequent components and operations, which sometimes occur in parallel.

In various implementations, the search results system performs grounding data retrieval. For example, a grounding data retrieval system identifies grounding data based on keywords from the search query. In some implementations, the search results system also determines a search intent from the search query, which is used to fetch relevant data from a variety of indexed sources. These indexed sources can include documents, articles, or knowledge graphs. The retrieved grounding data often includes various levels of detail and complexity, depending on the specificity of the search query. In various instances, the grounding data includes information associated with, but often not focused on, the search query (e.g., a website with dozens of paragraphs includes a single paragraph related to the search query).

Act 306 includes the search results system retrieving search results. In particular, the search results system obtains grounding data 308, which can include website links, related answers, and other content corresponding to the search query. As mentioned above, in various implementations, the search results system obtains a large amount of grounding data such that the amount of obtained grounding data exceeds the token limit of a generative AI model.

Act 310 includes generating compressed grounding data. As mentioned, the grounding compression system 210 generates compressed grounding data 312. The compressed grounding data 312 can be generated as summarized grounding data 314 or embedded grounding data 316 (e.g., dense vector embeddings).

In various implementations, the grounding compression system 210 first generates summarized grounding data 314 from the grounding data 308, then generates embedded grounding data 316 from the summarized grounding data 314. In some implementations, the grounding compression system 210 determines whether to perform one or both compressed grounding data formats based on whether one or both compression approaches are needed to reduce the data to below the token limit of the generative AI model. For example, if either the summarized grounding data 314 or the embedded grounding data 316 alone is sufficient to lower the volume of the grounding data 308 to below the token limit, the grounding compression system 210 determines not to perform both compression operations.

In various implementations, the grounding compression system 210 identifies the token limit for the generative AI model (e.g., the queries an interface of the generative AI model regarding the token limit and stores the token limit). In addition, the grounding compression system 210 determines the amount of compression to apply and/or the number of compression steps to take based on compressing the grounding information to be below the token limit. For instance, the grounding compression system 210 determines whether to apply summarization, embedding, or both to the grounding data to reduce the data to below the token limit

In many implementations, by prioritizing, pruning, culling, and being selective about the grounding data that is compressed, either operations (e.g., summarization or embedding) reduce the grounding data to below the token limit. In some implementations, the grounding compression system 210 prioritizes the information in the grounding data and continues to select and compress the next highest priority information until the token limit is met (or met within a buffer amount). By doing so, the grounding compression system 210 can provide the most valuable and pertinent grounding data to the generative AI model in a single prompt.

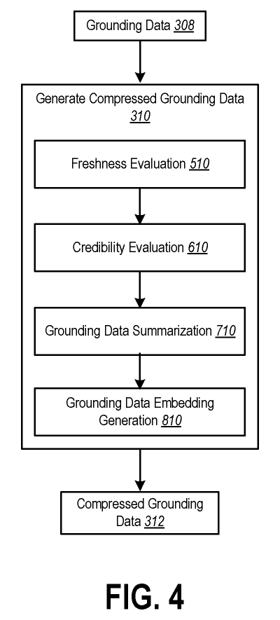

In some implementations, the grounding compression system determines whether to perform one or both compressed grounding data formats based on available time. For example, if the search results system has 5 seconds to provide a real-time search query response, generating the summarized grounding data takes 3 seconds, and generating the embedded grounding data 316 takes 4 seconds, then the grounding compression system 210 performs only one of the operations. However, if time is not constrained or the total time is within the available time, the grounding compression system 210 can perform both operations. As mentioned, additional details about generating compressed grounding data are provided below in connection with FIGS. 4-8.

Act 318 includes generating a search query prompt. For instance, the grounding compression system 210 generates a search query prompt based on the search query 304 and the compressed grounding data 312. In various implementations, the grounding compression system 210 provides the compressed grounding data 312 within the search query prompt. In some implementations, the compressed grounding data 312 is provided to the generative AI model alongside the search query prompt.

Act 320 includes generating a search query response. In various implementations, the generative AI model 240 processes the search query prompt and the search query according to the compressed grounding data 312 to generate a search query response 322. As mentioned, the compressed grounding data 312, which is within or under the token limit of the client device 250, enables the client device 250 to quickly and efficiently generate accurate and coherent responses.

Indeed, in various implementations, the search query prompt instructs the generative AI model 240 to identify the compressed grounding data 312 (whether in the form of summaries or embeddings) and generate a coherent, contextually appropriate response. By doing so, the generative AI model 240 generates a search query response 322 that is based on both the original search query and insights contained within the compressed grounding data.

Act 324 includes refining the search query response. In various implementations, the search results system and/or the grounding compression system 210 formats the search query response 322 into a user-friendly layout to enhance the readability and the digestibility of the generative response.

Act 326 includes returning the refined search query response to the client device 250. As shown, the search results system provides either the search query response or the refined search query response to the requesting user via the client device 250. Indeed, the search results system provides a generative response that is both easily understood and aligned with the search query. Furthermore, the grounding compression system 210 achieves these results by leveraging compression techniques to minimize the amount of time and data that the generative AI model requires to generate the search query response.

As mentioned above, FIG. 4 illustrates a high-level flow diagram for generating compressed grounding data for a search query according to some implementations. As shown, FIG. 4 includes grounding data 308, act 310 of generating compressed grounding data, and compressed grounding data 312. Indeed, the grounding compression system 210 can generate the compressed grounding data 312 from the grounding data 308.

Furthermore, FIG. 4 shows various operations that the grounding compression system 210 performs on the grounding data 308 to generate the compressed grounding data 312. As illustrated, generating compressed grounding data includes freshness evaluation 510, credibility evaluation 610, grounding data summarization 710, and grounding data embedding generation 810. The grounding compression system 210 may perform some or all of these operations to generate the compressed grounding data 312. For instance, the grounding compression system 210 performs one or more operations to continue to reduce the size of the compressed grounding data until the size of the compressed grounding data is below a token limit if a generative AI model. In some implementations, the grounding compression system 210 also performs additional and/or different operations.

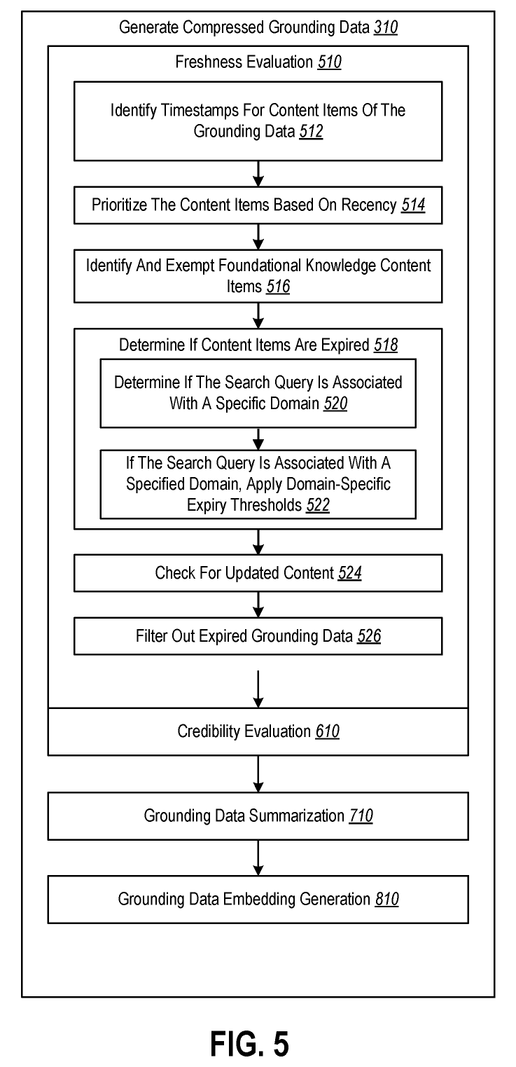

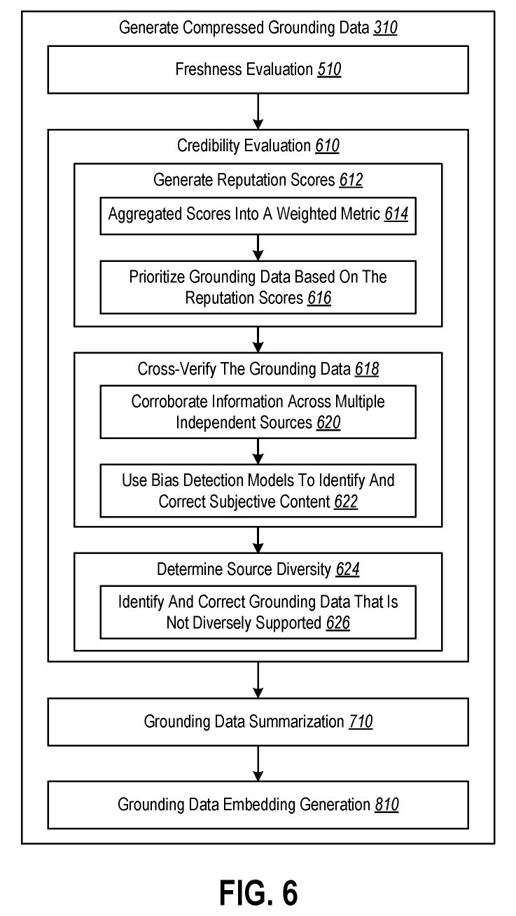

Each of the operations of act 310 is expanded in subsequent figures. To elaborate, as indicated by the call-out numbers, the freshness evaluation 510 is further detailed in FIG. 5, the credibility evaluation 610 is elaborated upon in FIG. 6, the grounding data summarization 710 is expanded in FIG. 7, and the grounding data embedding generation 810 is further described in FIG. 8.

As previously mentioned, FIG. 5 provides additional details regarding the evaluation of grounding data for freshness as part of generating compressed grounding data. In particular, FIG. 5 illustrates a flow diagram for performing a freshness evaluation during the generation of compressed grounding data for a search query according to some implementations. By assessing or evaluating for content freshness, the grounding compression system 210 ensures the reliability of the search query responses, especially in applications where up-to-date information is critical.

As mentioned above, FIG. 5 shows act 310 of generating compressed grounding data, with a focus on expanding the freshness evaluation 510. The grounding compression system 210 may perform some or all of the included acts. Similarly, the grounding compression system 210 may execute additional and/or different acts to perform a freshness evaluation.

As shown, the freshness evaluation 510 operation includes a first act 512 of identifying timestamps for content items of the grounding data. For example, the grounding compression system 210 performs a timestamp analysis to determine data relevance based on age by identifying a timestamp associated with each content item. The timestamp can include a creation time or the last modified timestamp.

Act 514 includes prioritizing the content items based on recency. For example, the grounding compression system 210 prioritizes the content items according to their timestamp, ordering the grounding data from the oldest to the newest. For instance, older content is assigned lower relevance.

Act 516 includes identifying and exempting foundational knowledge content. In various implementations, the grounding compression system 210 identifies content items that hold long-term value regardless of their timestamps, such as content items that include historical references or foundational knowledge. The grounding compression system 210 can prioritize these items or exempt them from the recently prioritized list.

Act 518 includes determining whether content items are expired. In various implementations, the grounding compression system 210 utilizes a dynamic expiry mechanism to automatically filter out data that exceeds a predefined recency threshold. For content items with a timestamp older than a predefined age or below a predetermined number of content items (e.g., outside of the top 1,000 items), the grounding compression system 210 removes the content items from the grounding data. This can ensure that outdated information does not inadvertently influence responses.

In some implementations, the grounding compression system 210 performs a first sub-act 520 of determining whether the search query is associated with a specific domain. For instance, the grounding compression system 210 determines if the search query (or obtained grounding data) is related to breaking news articles, academic publications, or technical manuals. If so, the grounding compression system 210 performs the second sub-act 522 of applying domain-specific expiry thresholds. For instance, breaking news articles may have a shorter lifespan than academic publications. Accordingly, based on the determined domain type of the search query and/or grounding data, the grounding compression system 210 may utilize a domain-specific recency threshold.

Act 524 includes checking for updated content. In various implementations, the grounding compression system 210 uses update detection monitors to track or monitor changes in content, such as modifications to articles, entries, or datasets. In this way, the grounding compression system 210 ensures that the most current versions of content items are used. For example, in cases involving ongoing events, the grounding compression system 210 dynamically adjusts its priorities to emphasize real-time data, enabling timely and contextually relevant responses.

Act 526 includes filtering out expired grounding data. For instance, the grounding compression system 210 applies the default recency threshold and/or a domain-specific recency threshold to filter out expired content items. Indeed, the grounding compression system 210 can remove grounding data that does not satisfy one or more recency thresholds. In this way, fresh data is given priority, ensuring that search queries are answered with the latest, most relevant information/

As mentioned, FIG. 6 provides additional details regarding the evaluation of grounding data for credibility as part of generating compressed grounding data. In particular, FIG. 6 illustrates a flow diagram of performing a credibility evaluation during the generation of compressed grounding data for a search query according to some implementations. By evaluating content credibility, the grounding compression system 210 ensures trustworthiness in the search query responses, especially in applications where accurate information is critical. Indeed, credibility assessments check the reliability of the sources from which the data is retrieved, ensuring that the system is not generating responses based on unreliable content. Furthermore, the credibility evaluation 610 complements freshness checks by focusing on the reliability and accuracy of the data sources.

As mentioned, FIG. 6 shows act 310 of generating compressed grounding data, with a focus on expanding the credibility evaluation 610. The grounding compression system 210 may perform some or all of the included acts. Similarly, the grounding compression system 210 may perform additional and/or different acts to perform a freshness evaluation.

As shown, the credibility evaluation 610 operation includes a first act 612 of generating reputation scores. In various implementations, the grounding compression system 210 generates reputation scores to assess historical accuracy, domain authority, and peer-reviewed validation of grounding data. In various implementations, the generating reputation scores for grounding data content items includes a first sub-act 614 of aggregating the scores into a weighted metric. Furthermore, the grounding compression system 210 may perform a second sub-act 616 of prioritizing the grounding data content items based on the reputation scores.

Act 618 includes cross-verifying the grounding data. This can include a first sub-act 620 of corroborating information across multiple independent sources. In various implementations, this can reduce the risk of errors or biases that could negatively influence the generative AI model. In addition, the grounding compression system 210 can perform a second sub-act 622 of using bias detection models to identify and correct subjective content. For example, the grounding compression system 210 utilizes one or more bias detection algorithms that analyze the linguistic patterns and framing of content items to identify subjective or skewed content. If biased content items are detected, the grounding compression system 210 can take corrective measures to ensure that the final output remains neutral and balanced.

Act 624 includes determining source diversity. This can ensure that the grounding data incorporates data from a wide array of sources, which minimizes the risk of over-reliance on any single perspective. In some instances, the grounding compression system 210 performs a sub-act 626 of identifying and tracking grounding data that is not diversely supported. For example, the grounding compression system 210 attempts to identify additional sources of grounding data that are supported by fewer than a specified threshold of sources. Enforcing diversity can enhance the robustness and fairness of the grounding data.

In various implementations, by prioritizing fresh and credible data, the grounding compression system 210 enhances the accuracy and coherence of the responses it generates. For example, in contexts where current events or rapidly changing information is important (e.g., finance, healthcare, and technology), the grounding compression system 210 ensures that users receive timely and accurate answers.

As mentioned above, FIG. 7 provides additional details regarding the user of query-based summarization to generate compressed grounding data. For instance, FIG. 7 illustrates a flow diagram of performing grounding data summarization as part of generating compressed grounding data for a search query according to some implementations.

As mentioned, FIG. 7 shows act 310 of generating compressed grounding data, with a focus on expanding the grounding data summarization 710. In various implementations, the grounding compression system 210 can perform the freshness evaluation 510 and/or the credibility evaluation 610 before performing the grounding data summarization 710. As shown, the grounding data summarization 710 includes various acts.

Act 712 of the grounding data summarization 710 includes cleaning the grounding data. In various implementations, the grounding compression system 210 can begin by preprocessing the grounding data to remove noisy content (sub-act 714). For example, because grounding data often includes documents, articles, or snippets retrieved from various sources, the grounding compression system 210 performs preprocessing to clean and standardize the grounding data content. In various implementations, removing noisy content involves eliminating removing HTML tags, special characters, and encoding errors.

Act 716 includes tokenizing the grounding data. In some instances, after cleaning the grounding data, the grounding compression system 210 tokenizes the grounding data content into manageable components. For example, the grounding compression system 210 segments the generative document system (e.g., text portions of the content) into units such as sentences, words, or sub-words, which are then tokenized.

Act 718 includes generating an extractive summary of the grounding data. For instance, the grounding compression system 210 generates concise summaries of the grounding data text while retaining its essential meaning and context. This mode is particularly valuable for tasks where human interpretability and readability are prioritized. In various implementations, the grounding compression system 210 identifies the most relevant portions of the input text through summarization techniques and operations.

To illustrate, act 718 includes two sub-acts, a first sub-act 720 of generating an extractive summary and a second sub-act 728 of generating a disclosure-based summary. In various instances, extractive summarization involves selecting key sentences or phrases from the source text to construct a summary, while the disclosure-based summary analyzes the rhetorical structure of the text, focusing on sentences that contribute to its main narrative.

As shown, the first sub-act 720 of generating an extractive summary includes three additional sub-acts of applying extractive summarization operations to generate extractive summaries. While example operations are provided, in some instances, the grounding compression system 210 utilizes different extractive summarization techniques and operations.

The first sub-act 722 includes generating an extractive summary using a graph-based model to generate a similarity graph for identifying sentences central to the search query. In various implementations, the grounding compression system 210 utilizes a graph-based algorithm to identify sentences that are most central to the text’s semantic structure by analyzing the relationships between sentences within a similarity graph.

In some implementations, the graph-based algorithm includes an unsupervised algorithm for text summarization, which employs a graph-based approach to identify key sentences within a document. The graph-based algorithm may represent sentences as nodes in a graph, with edges weighted by the cosine similarity between them. The grounding compression system 210 may also use a graph-based algorithm to calculate the importance of each sentence using eigenvector centrality, which assesses how well-connected a node is to other significant nodes. In this way, sentences that are similar to many others, as well as to the search query, are deemed important and included in the summary.

The second sub-act 724 includes using a clustering model to identify content that is semantically similar to the search query and extract representative sentences. In various implementations, the grounding compression system 210 utilizes a cluster-based approach that performs text summarization by grouping sentences into clusters based on their semantic similarity with the search query. This approach ensures that sentences within each cluster share a common theme or topic, often relating to the search query. By extracting representative sentences from each cluster, the grounding compression system 210 ensures that the summary covers a wide range of topics discussed in the original document as they relate to the search query. As a result, the grounding compression system 210 provides a comprehensive overview of the content with a focus on the search query.

The third sub-act 726 includes using a frequency-based model to identify critical aspects of the grounding data that are similar to the search query. In one or more implementations, the grounding compression system 210 uses frequency-based techniques to generate a text summary that focuses on identifying and prioritizing sentences that contain terms with high frequency or relevance to the search query. By doing so, the grounding compression system 210 can capture the critical aspects of the grounding data. In addition, the approach ensures that the generated summary highlights key points and important information, making it particularly useful for quickly understanding the main ideas of a document. By emphasizing frequently occurring or highly relevant terms, frequency-based techniques can provide a concise and informative summary that effectively conveys the essence of the grounding data as it relates to the search query.

Returning to the second sub-act 728 of generating a disclosure-based summary, the grounding compression system 210 may perform the further sub-act 730 of analyzing rhetorical structures of the grounding data to identify narratives focused on the search query. In some implementations, the grounding compression system 210 uses discourse-based summarization to analyze the rhetorical structure of a text and identify sentences that contribute significantly to its main narrative as it relates to the search query. For example, by examining how sentences function within the overall discourse, the grounding compression system 210 can generate a summary that captures the essential elements and logical flow of the grounding data concerning to the search query. This technique can be particularly effective in maintaining the coherence and integrity of the summary, as it focuses on sentences that play a crucial role in conveying the primary message and supporting arguments of the grounding data focused on the search query.

Act 732 includes refining the selected grounding data. In various implementations, the grounding compression system 210 organizes, sorts, prioritizes, and/or reorders the generated summarized grounding data. For example, the grounding compression system 210 utilizes one or more graph centrality algorithms to further refine the generated summary by identifying influential sentences based on their interconnectivity, as shown in sub-act 734.

Act 736 includes reordering the grounding data based on positional weighting. As shown, sub-act 738 includes using a positional weighting model to prioritize grounding data that appears in key positions within the search results. In various implementations, the grounding compression system 210 uses positional weighting techniques to prioritize sentences appearing in key positions, such as introductions or conclusions, to leverage their likelihood of containing vital information.

Act 740 includes removing redundant content. For example, after selecting the most relevant sentences, the grounding compression system 210 removes and/or minimizes redundancy. Act 742 includes verifying summary coherency. For instance, the grounding compression system 210 performs one or more coherence checks to ensure that the generated summary is concise, readable, diverse, and related to the search query.

In various implementations, the compressed grounding data results in summarized grounding data that is human-readable and encapsulates the key points of the grounding data without unnecessary detail, making it easier for the generative AI model to grasp the core information quickly and efficiently.

As mentioned above, FIG. 8 provides additional details regarding the use of embedding generation to create or generate compressed grounding data. For instance, FIG. 8 illustrates a flow diagram of creating dense vector embeddings as part of generating compressed grounding data for a search query according to some implementations.

As mentioned, FIG. 8 shows act 310 of generating compressed grounding data, with a focus on expanding the grounding data embedding generation 810. In various implementations, the grounding compression system 210 can perform the freshness evaluation 510, the credibility evaluation 610, and/or the grounding data summarization 710 before performing the grounding data embedding generation 810. As shown, the grounding data embedding generation 810 includes various acts.

Act 812 includes cleaning the grounding data. If not cleaned as described above in connection with act 712, the grounding compression system 210 can clean the grounding data, as described above, including preprocessing the grounding data to remove noisy content (sub-act 814). Once cleaned, the grounding compression system 210 can also perform act 816 of tokenizing the grounding data, if not previously done, as described above.

Act 818 includes the grounding compression system 210 performing feature extraction. In various implementations, the grounding compression system 210 utilizes advanced linguistic techniques, such as Named Entity Recognition (NER) and Part-of-Speech (POS) tagging, to identify key semantic elements within the grounding data (sub-act 820). For example, the grounding compression system 210 performs feature extraction to identify entities, relationships, and grammatical structures within the grounding data, which can correspond to the search query.

Act 822 includes the grounding compression system 210 performing data pruning. For example, the grounding compression system 210 identifies and removes and/or reduces duplicate elements (sub-act 824) from the extracted features.

Act 826 includes generating dense vector embeddings. In various implementations, the grounding compression system 210 utilizes an embedding machine learning model (or embedding neural network) to generate dense vector embeddings, as shown in sub-act 828. For example, the grounding compression system 210 obtains and utilizes a pre-trained embedding model, like Sentence-BERT or the Universal Sentence Encoder, to generate dense vector embeddings. Dense vector embeddings capture the meaning and context of the text in a numerical format, enabling efficient computation, retrieval, and clustering. The grounding compression system 210 may use other approaches, operations, and/or techniques to generate dense vector embeddings from grounding data.

Act 830 includes embedding refinement. In various implementations, the grounding compression system 210 reduces the dimensionality of the embeddings (sub-act 832). For example, the grounding compression system 210 applies a dimensionality reduction technique, such as principal component analysis (PCA), to reduce the dimensionality of the dense vector embeddings. By reducing embedding dimensionality, the grounding compression system 210 can provide embeddings that are both computationally efficient and semantically rich.

In various implementations, the grounding compression system 210 applies domain-specific applications. For example, for particular domains, such as legal, medical, or academic contexts, the grounding compression system 210 utilizes additional or alternative embedding processing. To illustrate, act 834 includes domain-specific fine-tuning. For instance, for particular domains, the grounding compression system 210 fine-tunes the dense vector embeddings on specialized domain-based datasets to ensure enhanced accuracy and relevance. This is shown in sub-act 836, where the grounding compression system 210 fine-tunes the dense vector embeddings using a specialized domain dataset.

As a result of the grounding data embedding generation 810, the grounding compression system 210 creates a set of dense embeddings that effectively represent the grounding data. This, in turn, can significantly reduce processing overhead and improve scalability for large-scale data tasks.

In various implementations, the grounding data is multimodal. For instance, it includes text, images, and videos. In some instances, the grounding compression system 210 utilizes the appropriate text, image, or video processing and embedding models to generate dense vector embeddings from these input types. Indeed, the grounding compression system 210 can use a variety of embedding encoders to generate compressed grounding data and/or grounding embeddings (i.e., dense vector embeddings) from the grounding data. Furthermore, the embedding encoders can encode multiple types of modalities, including spatiotemporal data, time series data, and graph data into dense vector embeddings.

As mentioned above, in various implementations, the grounding compression system 210 first performs grounding data summarization, followed by the grounding compression system 210 executing the grounding data embedding generation on the summarized grounding data. Together, these two sets of actions further enhance the process of generating compressed grounding data, as they serve complementary roles within the compression operations. Indeed, as one example of this synergistic relationship, summarizing the grounding data enhances the focus on the search query and usability, while generating dense vector embeddings optimizes the compressed data for computational efficiency and machine interpretability. As another example, summarizing the grounding data condenses long and complex information (e.g., raw grounding data) while retaining its key points, and generating dense vector embeddings can significantly reduce the amount of data that needs to be processed, ultimately enhancing computational efficiency.

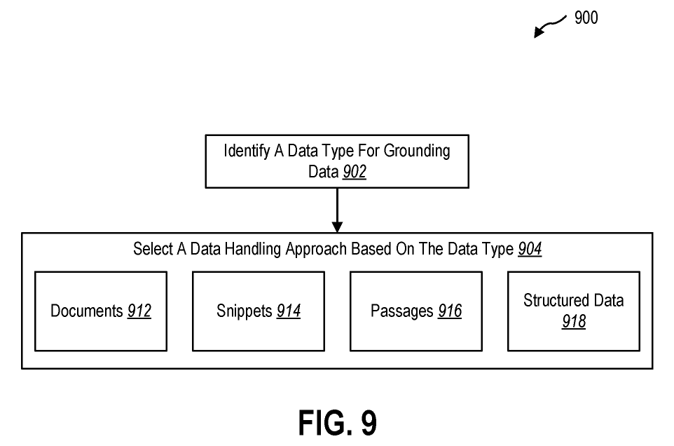

FIG. 9 illustrates a flow diagram for performing data handling with grounding data for a search query. Just as various implementations of the grounding compression system 210 can process multimodal inputs to generate summaries and/or embeddings, the grounding compression system 210 can also handle different data types found within grounding data.

In various implementations, the grounding compression system 210 applies a tailored approach for different types of grounding data. To illustrate, FIG. 9 shows a series of acts 900 for handling different types of grounding data. As shown, the series of acts 900 includes act 902 of identifying a data type for grounding data (e.g., search result content). For example, the grounding compression system 210 identifies search result content that includes documents, snippets, passages, or structured data.

In various instances, documents are collections of text and occasionally images, providing information about a certain topic or subject. Documents can be lengthy and detailed. Snippets are typically short text fragments. Passages are often large paragraphs or sections of text. Structured data can include tables, databases, markup languages, or programming code. The grounding compression system 210 can identify other data types.

Act 904 includes selecting a data handling approach based on the data type. As shown, act 904 includes a data handling approach for documents 912, snippets 914, passages 916, and structured data 918. To elaborate, for documents 912, the grounding compression system 210 can summarize the content and/or convert it into embeddings to distill the key information into a more manageable format. As provided above, these actions enable efficient processing of grounding data by the generative AI model and ensure that only the most pertinent data is used in response generation.

For snippets 914, the grounding compression system 210 can utilize token pruning or embedding techniques to further compress the data. Token pruning eliminates extraneous words, while embeddings provide a semantic understanding of the snippet in a compact form, ensuring that every bit of information is relevant to the query.

For passages, the grounding compression system 210 can extract and summarize only the most important sentences or segments. In this way, the grounding compression system 210 preserves the essential information while removing irrelevant sections, making the data easier to process and more focused on the user’s needs.

For structured data, such as tables or databases, the grounding compression system 210 extracts and transforms the relevant fields or entries into embeddings. In this way, the grounding compression system 210 can represent structured data in a semantic, context-sensitive form that can be processed alongside other types of unstructured data, ensuring a seamless response generation process. Indeed, by processing the different data types according to their type, the grounding compression system 210 can ensure that all forms of input are processed effectively, maintaining both accuracy and efficiency throughout the entire query processing cycle.

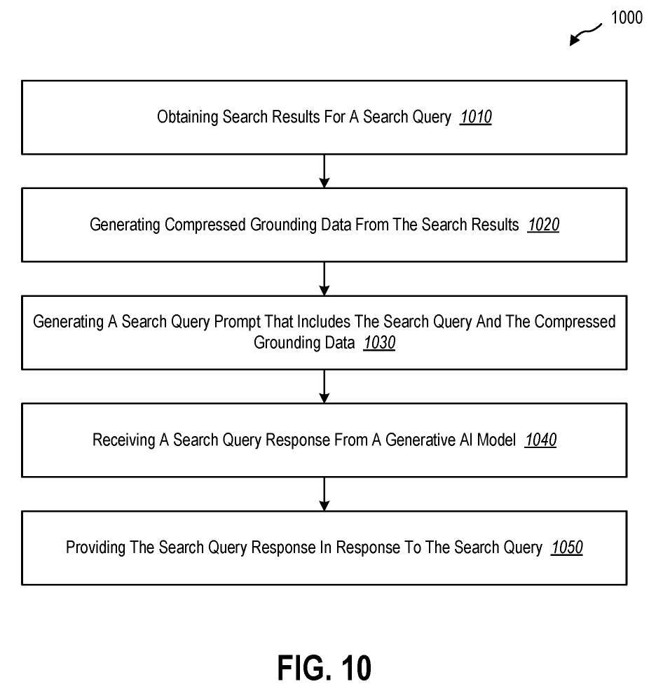

Turning now to FIG. 10, this figure illustrates an example series of acts of a computer-implemented method for providing one or more query responses using one or more artificial intelligence models according to some implementations. While FIG. 10 illustrates acts according to one or more implementations, alternative implementations may omit, add to, reorder, and/or modify any of the acts shown.

The acts in FIG. 10 can be performed as part of a method (e.g., a computer-implemented method). Alternatively, a computer-readable medium can include instructions that, when executed by a processing system with a processor, cause a computing device to perform the acts in FIG. 10. In some implementations, a system (e.g., a processing system comprising a processor) can perform the acts in FIG. 10. For example, the system includes a processing system and a computer memory including instructions that, when executed by the processing system, cause the system to perform various actions or steps.

As shown, the series of acts 1000 includes act 1010 of obtaining search results for a search query. For instance, in example implementations, act 1010 involves obtaining, in response to receiving a search query, search results from a search system, the search results including website links and related answers. In various implementations, act 1010 includes extracting keywords from the search query and determining a search intent based on the search query. In some implementations, obtaining the search results includes identifying search results that correspond to the keywords and the search intent of the search query. In some implementations, act 1010 includes determining that the search result content within the search results includes unstructured data.

As further shown, the series of acts 1000 includes act 1020 of generating compressed grounding data from the search results. For instance, in example implementations, act 1020 involves generating compressed grounding data from the search results by refining the search results to below a token limit of a generative AI model. In some implementations, refining the search results includes creating a distilled search query summary of the search results by generating concise summaries of search result content with a focus on the search query and generating dense vector embeddings of the search results from the distilled search query summary. In various implementations, generating the compressed grounding data reforms the search result content into one or more forms of structured data.

In one or more implementations, act 1020 includes generating compressed grounding data according to a token limit of a generative AI model by creating a distilled search query summary of the search results, by generating concise summaries of search result content with a focus on the search query, or by generating dense vector embeddings from the search results, the dense vector embeddings being a machine-readable representation of the semantic content of the search results. In some implementations, act 1020 includes generating compressed grounding data from the search results by creating a distilled search query summary of the search results, by generating concise summaries of search result content with a focus on the search query, and/or by generating dense vector embeddings of the search results from the distilled search query summary.

In various implementations, refining the search results includes creating a distilled search query summary of the search results by generating concise summaries of search result content with a focus on the search query. In some instances, generating concise summaries of the search result content includes using an extractive summarization model to extract key phrases that focus on the search query. In some instances, the extractive summarization model includes a graph-based algorithm that identifies phrases that are semantically similar to the search query using a similarity graph.

In one or more implementations, act 1020 includes refining the distilled search query summary by identifying influential sentences within the search result content using a graph centrality model that determines interconnectivity between sentences within the search result content. In some instances, refining the search results includes creating the distilled search query summary using a disclosure-based summarization model that analyzes the rhetorical structures of the search result content to identify narratives focused on the search query.

In some implementations, act 1020 includes prioritizing sentences based on the relative positioning of the sentences within search result documents corresponding to the website links. In some instances, the distilled search query summary captures key phrases of the search results in a human-readable form. In some cases, refining the search results includes generating dense vector embeddings from the search results, the dense vector embeddings being a machine-readable representation of the semantic content of the search results.

In one or more implementations, generating the dense vector embeddings from the search results includes extracting search result features using advanced linguistic models to identify key semantic elements within the search results and generating the dense vector embeddings utilizing an encoding model to capture the meanings and contexts of the search results in feature vectors. In various implementations, act 1020 includes refining the dense vector embeddings by reducing the dimensionality of the dense vector embeddings.

In various implementations, act 1020 includes determining that the search query corresponds to a predetermined domain and fine-tuning the dense vector embeddings using a specialized dataset corresponding to the predetermined domain. In some instances, refining the search results includes reducing the token volume of the search results to within the token limit of the generative AI model based on the relevance, freshness, and credibility of the search results in relation to the search query. For example, the least relevant, least fresh, and/or least credible compressed grounding data is removed until the size and volume of the compressed grounding data is below the token limit. The grounding compression system may remove compressed grounding data using one or all approaches until the token limit is satisfied. In some instances, the grounding compression system may use a round-robin format to reduce the volume of compressed grounding data from each approach until the token limit is satisfied. In some instances, the grounding compression system may remove equal amounts using each approach until the token limit is satisfied. In some implementations, generating the compressed grounding data from the search results includes providing the search query and the search results to a compressed grounding data datastore and receiving a previously refined version of the compressed grounding data.

As further shown, the series of acts 1000 includes act 1030 of generating a search query prompt that includes the search query and the compressed grounding data. For instance, in example implementations, act 1030 involves generating a search query prompt that includes the search query and the compressed grounding data to provide to the generative AI model to generate a response to the search query based on grounding information from the compressed grounding data. In various implementations, the search query prompt includes instructions to generate the search query response based on grounding information provided in the compressed grounding data.

As shown further, the series of acts 1000 includes act 1040 of receiving a search query response from a generative AI model. For instance, in example implementations, act 1040 involves receiving a search query response from the generative AI model in response to providing the search query prompt to the generative AI model. In one or more implementations, act 1040 includes providing the search query prompt to the generative AI model in a single call, wherein the search query prompt with the compressed grounding data is combined to be below the token limit of the generative AI model.

As shown further, the series of acts 1000 includes act 1050 of providing the search query response in response to the search query. In some implementations, act 1050 includes formatting the search query response into a structured response before providing the search query response in response to the search query.

FIG. 11 illustrates certain components that may be included within a computer system 1100. The computer system 1100 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1100 represents one or more of the client devices, server devices, or other computing devices described above. For example, the computer system 1100 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1100 includes a processing system including a processor 1101. The processor 1101 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1101 may be referred to as a central processing unit (CPU) and may cause computer-implemented instructions to be performed. Although the processor 1101 shown is just a single processor in the computer system 1100 of FIG. 11, in an alternative configuration, a combination of processors (e.g., an ARM and DSP) could be used.

The computer system 1100 also includes memory 1103 in electronic communication with the processor 1101. The memory 1103 may be any electronic component capable of storing electronic information. For example, the memory 1103 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1105 and the data 1107 may be stored in the memory 1103. The instructions 1105 may be executable by the processor 1101 to implement some or all of the functionality disclosed herein. Executing the instructions 1105 may involve the use of the data 1107 that is stored in the memory 1103. Any of the various examples of modules and components described herein may be implemented, partially or wholly, as instructions 1105 stored in memory 1103 and executed by the processor 1101. Any of the various examples of data described herein may be among the data 1107 that is stored in memory 1103 and used during the execution of the instructions 1105 by the processor 1101.

A computer system 1100 may also include one or more communication interface(s) 1109 for communicating with other electronic devices. The one or more communication interface(s) 1109 may be based on wired communication technology, wireless communication technology, or both. Some examples of the one or more communication interface(s) 1109 include a Universal Serial Bus (USB), an Ethernet adapter, a wireless adapter that operates according to an Institute of Electrical and Electronics Engineers (IEEE) 1102.11 wireless communication protocol, a Bluetooth® wireless communication adapter, and an infrared (IR) communication port.

A computer system 1100 may also include one or more input device(s) 1111 and one or more output device(s) 1113. Some examples of the one or more input device(s) 1111 include a keyboard, mouse, microphone, remote control device, button, joystick, trackball, touchpad, and light pen. Some examples of the one or more output device(s) 1113 include a speaker and a printer. A specific type of output device that is typically included in a computer system 1100 is a display device 1115. The display device 1115 used with implementations disclosed herein may utilize any suitable image projection technology, such as liquid crystal display (LCD), light-emitting diode (LED), gas plasma, electroluminescence, or the like. A display controller 1117 may also be provided, for converting data 1107 stored in the memory 1103 into text, graphics, and/or moving images (as appropriate) shown on the display device 1115.

The various components of the computer system 1100 may be coupled together by one or more buses, which may include a power bus, a control signal bus, a status signal bus, a data bus, etc. For clarity, the various buses are illustrated in FIG. 11 as a bus system 1119.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for providing one or more query responses using one or more artificial intelligence (AI) models, comprising:
in response to receiving a search query, obtaining search results from a search system, the search results including website links and related answers;
generating compressed grounding data from the search results by refining the search results to below a token limit of a generative AI model;
generating a search query prompt that includes the search query and the compressed grounding data to provide to the generative AI model to generate a response to the search query based on grounding information from the compressed grounding data;
receiving a search query response from the generative AI model in response to providing the search query prompt to the generative AI model; and
providing the search query response in response to the search query.

2. The computer-implemented method of claim 1, wherein refining the search results includes creating a distilled search query summary of the search results by generating concise summaries of search result content with a focus on the search query.

3. The computer-implemented method of claim 2, wherein generating the concise summaries of the search result content includes using an extractive summarization model to extract key phrases that focus on the search query.

4. The computer-implemented method of claim 3, wherein the extractive summarization model includes a graph-based algorithm that identifies phrases that are semantically similar to the search query using a similarity graph.

5. The computer-implemented method of claim 1, wherein refining the search results includes creating a distilled search query summary using a disclosure-based summarization model that analyzes rhetorical structures of search result content to identify narratives focused on the search query.

6. The computer-implemented method of claim 2, further comprising prioritizing sentences based on relative positioning of the sentences within search result documents corresponding to the website links.

7. The computer-implemented method of claim 2, wherein the distilled search query summary captures key phrases of the search results in a human-readable form.

8. The computer-implemented method of claim 1, wherein refining the search results includes generating dense vector embeddings from the search results, the dense vector embeddings being a machine-readable representation of semantic content of the search results.

9. The computer-implemented method of claim 8, wherein generating the dense vector embeddings from the search results includes:
extracting search result features using advanced linguistic models to identify key semantic elements within the search results; and
generating the dense vector embeddings utilizing an encoding model to capture meanings and contexts of the search results in feature vectors.

10. The computer-implemented method of claim 9, further comprising refining the dense vector embeddings by reducing dimensionalities of the dense vector embeddings.

11. The computer-implemented method of claim 9, further comprising:
determining that the search query corresponds to a predetermined domain; and
fine-tuning the dense vector embeddings using a specialized dataset corresponding to the predetermined domain.

12. The computer-implemented method of claim 1, wherein refining the search results includes:
creating a distilled search query summary of the search results by generating concise summaries of search result content with a focus on the search query; and
generating dense vector embeddings of the search results from the distilled search query summary.

13. The computer-implemented method of claim 1, wherein the search query prompt includes instructions to generate the search query response based on the grounding information provided in the compressed grounding data.

14. The computer-implemented method of claim 1, further comprising providing the search query prompt to the generative AI model in a single call, wherein the search query prompt with the compressed grounding data is combined to be below the token limit of the generative AI model.

15. The computer-implemented method of claim 1, further comprising formatting the search query response into a structured response before providing the search query response in response to the search query.

16. The computer-implemented method of claim 1, further comprising:
extracting keywords from the search query; and
determining a search intent based on the search query,
wherein obtaining the search results includes identifying search results that correspond to the keywords and the search intent of the search query.

17. The computer-implemented method of claim 1, wherein generating the compressed grounding data from the search results includes:
providing the search query and the search results to a compressed grounding data datastore; and
receiving a previously refined version of the compressed grounding data.

18. A system comprising:
a processing system; and
a computer memory comprising instructions that, when executed by the processing system, cause the system to perform operations of:
in response to receiving a search query, obtaining search results from a search system;
generating compressed grounding data according to a token limit of a generative AI model by:
creating a distilled search query summary of the search results by generating concise summaries of search result content with a focus on the search query; or
generating dense vector embeddings from the search results, the dense vector embeddings being a machine-readable representation of semantic content of the search results;
generating a search query prompt that includes the search query and the compressed grounding data to provide to the generative AI model to generate a response to the search query based on grounding information from the compressed grounding data;
receiving a search query response from the generative AI model in response to providing the search query prompt to the generative AI model; and
providing the search query response in response to the search query.

19. The system of claim 18, wherein refining the search results includes reducing a token volume of the search results to within the token limit of the generative AI model based on relevance, freshness, and credibility of the search results in relation to the search query.

20. A computer-implemented method for providing one or more query responses using one or more artificial intelligence (AI) models, comprising:
in response to receiving a search query, obtaining search results from a search system;
generating compressed grounding data from the search results by:
creating a distilled search query summary of the search results by generating concise summaries of search result content with a focus on the search query; and
generating dense vector embeddings of the search results from the distilled search query summary;
generating a search query prompt that includes the search query and the compressed grounding data to provide to a generative AI model to generate a response to the search query based on grounding information from the compressed grounding data;
receiving a search query response from the generative AI model in response to providing the search query prompt to the generative AI model; and
providing the search query response in response to the search query.
